(19) United States
(12) Patent Application Publication
(10) Pub. No.: US 2010/0205184 A1
(43) Pub. Date: Aug. 12, 2010

(54) USING SPECIFICITY MEASURES TO RANK DOCUMENTS

(75) Inventors: Tomasz MARCINIAK, Welwyn Garden City (GB); Yoel David Marson, Winchmore Hill (GB)

Correspondence Address: HICKMAN PALERMO TRUONG & BECKER LLP/Yahoo! Inc., 2055 Gateway Place, Suite 550, San Jose, CA, 95110-1083, US

(73) Assignee: Yahoo! Inc., Sunnyvale, CA (US)

(21) Appl. No.: 12/368,932

(22) Filed: Feb. 10, 2009

(51) Int. Cl. G06F 17/30

(52) U.S. Cl. 707/750; 707/E17.017

(57) ABSTRACT

A method of ranking documents by specificity values includes specifying a reference set of documents, each document including one or more terms, and specifying a first document that includes one or more terms that are included in the reference set of documents. The method includes determining, from the reference set of documents, one or more term-specificity values for the one or more terms of the first document by calculating frequencies of terms within the reference set of documents, wherein a larger term-specificity value corresponds to a lower likelihood relative to the reference set of documents, and determining a document-specificity value for the first document by combining the one or more term-specificity values for the first document, wherein larger term-specificity values correspond to a larger document-specificity value.

### BACKGROUND OF THE INVENTION

1. Field of Invention

The present invention relates to ranking documents generally and more particularly to ranking documents according a specificity measure of the documents.

2. Description of Related Art

User-driven Internet portals such as Q/A (Question/Answer) sites and discussion forums often display recent contributions of their users on the front pages (e.g., recently asked questions, new discussion threads/topics, etc.). A specific example is the Y! Answers site that is supported by Yahoo! A common goal for these sites is to attract other users' attention and encourage them to contribute their responses.

Many sites serving UGC (User Generated Content) present the users' contributions in the reverse order of their submission (e.g., with most recent questions displayed on top) while others rely on costly manual selection of most interesting recent questions, opened threads, etc. In many cases when the contributions are presented in the order of submission, the top entries lack a specific focus that will attract other users' attention and prompt them to respond. Under these circumstances, an interesting contribution may be ignored because its presentation is unrelated to its distinctive qualities. Thus, there is a need for improved methods and related systems for ranking documents based on a measure of specificity that characterizes the distinctive qualities of the documents.

### SUMMARY OF THE INVENTION

In one embodiment of the present invention, a method of ranking documents by specificity values includes specifying a reference set of documents, each document including one or more terms, and specifying a first document that includes one or more terms that are included in the reference set of documents. The method includes determining, from the reference set of documents, one or more term-specificity values for the one or more terms of the first document by calculating frequencies of terms within the reference set of documents, wherein a larger term-specificity value corresponds to a lower likelihood relative to the reference set of documents, and determining a document-specificity value for the first document by combining the one or more term-specificity values for the first document, wherein larger term-specificity values correspond to a larger document-specificity value.

According to one aspect of this embodiment, one or more values for the document-specificity value of the first document can be saved in a computer-readable medium. For example, the document specificity value can be saved directly or through some related characterization in memory (e.g., RAM (Random Access Memory)) or permanent storage (e.g., a hard-disk system).

According to another aspect, the method may further include calculating term specificity values for terms in the reference set of documents as inverse document frequency values relative to the reference set of documents by comparing a number of documents including each term to a total number of documents.

According to another aspect, the method may further include calculating the document-specificity value for the first document as a non-negative arithmetic combination of the corresponding term specificity values.

According to another aspect, determining the document-specificity value for the first document may include calculating a norm of a vector that includes the corresponding term-specificity values.

According to another aspect, the reference set of documents may include the first document.

According to another aspect, the method may further include specifying a plurality of input documents that include one or more terms that are included in the reference set of documents, wherein the input documents include the first document. The method then includes: determining, from the reference set of documents, one or more term-specificity values for the one or more terms of each input document; and determining, from the one or more term-specificity values for each input document, a document-specificity value for each input document. Then a rank ordering of the input documents corresponding to an ordering of the document-specificity values of the documents can be determined, and one or more values for the rank ordering can be saved in the computer-readable medium.

Additional embodiments relate to an apparatus for carrying out any one of the above-described methods, where the apparatus includes a computer for executing instructions related to the method. For example, the computer may include a processor with memory for executing at least some of the instructions. Additionally or alternatively the computer may include circuitry or other specialized hardware for executing at least some of the instructions. Additional embodiments also relate to a computer-readable medium that stores (e.g., tangibly embodies) a computer program for carrying out any one of the above-described methods with a computer.

In these ways the present invention enables improved methods and related systems for ranking documents based on a measure of specificity that characterizes the distinctive qualities of the documents.

### BRIEF DESCRIPTION OF THE DRAWINGS

FIG. 1 shows method of ranking documents by specificity values according to an embodiment of the present invention.

FIG. 2 an exemplary listing of unranked documents for the embodiment shown in FIG. 1.

FIG. 3 shows an exemplary listing of ranked documents for the embodiment shown in FIG. 1.

FIG. 4 shows a system architecture for ranking documents by specificity values according to an embodiment of the present invention.

FIG. 5 shows a conventional general-purpose computer.

FIG. 6 shows a conventional Internet network configuration.

### DETAILED DESCRIPTION OF EXEMPLARY EMBODIMENTS

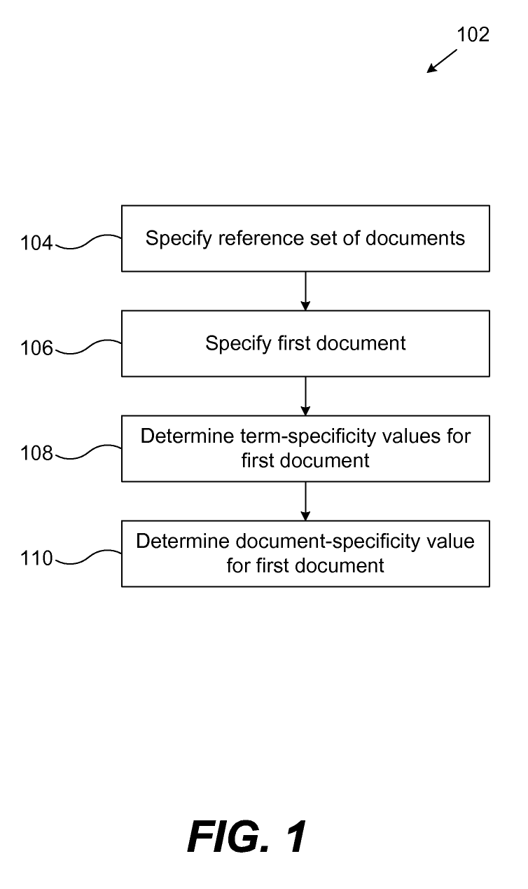

An embodiment of the present invention is shown in FIG. 1. A method 102 of ranking documents by specificity values includes: specifying a reference set of documents, where each document including one or more terms 104. In many cases, the documents are text-based UGC (User Generated Content) documents where the terms are words or other units of communication (e.g., groups of words, visual signals, sound). The method then includes specifying a first document that includes one or more terms that are included in the reference set of documents 106. (Note that the words first and second are used here and elsewhere for labeling purposes only and are not intended to denote any specific spatial or temporal ordering. Furthermore, the labeling of a first element does not imply the presence a second element.)

Next, the method includes determining, from the reference set of documents, one or more term-specificity values for the one or more terms of the first document 108. For example, this can be done by calculating frequencies of terms (e.g., words) within the reference set of documents so that a larger term-specificity value corresponds to a lower likelihood relative to the reference set of documents. In this way, the term-specificity values can reflect the context where the document appears (e.g., UGC documents at a specific web site). In a preferred embodiment, the term-specificity values are calculated as inverse document frequency values relative to the reference set of documents by comparing a number of documents including each term to a total number of documents.

In general, the Inverse Document Frequency (IDF) for a term tᵢ is computed as:

$$IDF ( {t}_{i} ) = - log ( \frac{{df}_{i}}{n} ) ,$$

where dfᵢ is the document frequency of term tᵢ (i.e., number of documents that contain term tᵢ) and n the total number of documents considered. (S. Robertson, 2004: “Understanding Inverse Document Frequency: On Theoretical Arguments for IDF,” Journal of Documentation 60, pp. 503-520.)

Next the method includes determining a Document-Specificity (DS) value for the first document by combining the one or more term-specificity values for the first document 110. In general, a formulas is used so that larger term specificity values in the first document correspond to a larger document specificity value. For example, the formula may define the document-specificity as a non-negative arithmetic combination of the corresponding term specificity values. As one convenient choice, a norm of the vector of term-specificity values can be used.

For example, For the first document d₁ ε D, build the IDF term vector v₁=[w₁₁, w₁₂, . . . ,w₁ₘ], where w₁ⱼ is the IDF weight of term tⱼ from document d₁. Then compute the DS measure of document d₁ as the Euclidean norm of vector v₁:

$$DS ( {d}_{1} ) = ‖ {v}_{1} ‖ = \sqrt{{\sum }_{j = 1}^{m} {w}_{1 j}^{2}} . \qquad ( 1 )$$

This process can be continued by introducing additional documents (e.g., second, third, fourth, etc.) and then using the document specificity values to rank the documents. This ranking can be displayed in real time (e.g., at the web site) or saved for later display or additional document analysis (e.g., augmenting the reference stet of documents). Depending on the requirements of the operational setting, the documents being ranked may also be included in the reference set of documents. Then for document dᵢ ε D, the DS measure of document dᵢ is computed as the Euclidean norm of vector vᵢ:

$$DS ( {d}_{i} ) = ‖ {v}_{i} ‖ = \sqrt{{\sum }_{j = 1}^{m} {w}_{ij}^{2}} . \qquad ( 2 )$$

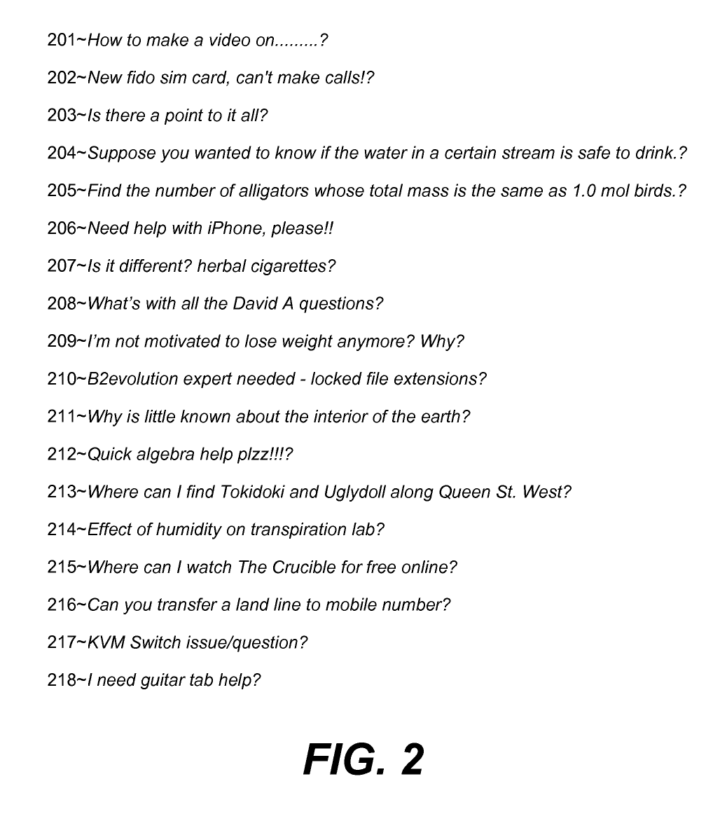

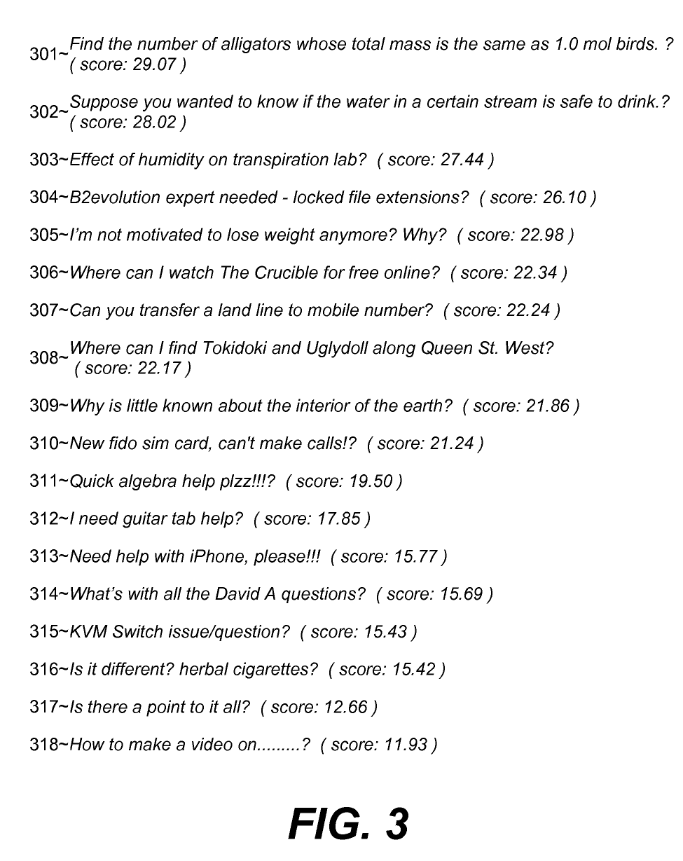

As discussed above, the documents may be text-based as illustrated in FIG. 2, which shows eighteen queries 201-218, which are characteristic of a Q/A site such as Y! Answers. FIG. 3 shows a ranking by scores calculated according to eq. (2). In this case, the term-frequency values were calculated according to the IDF formula given above where the reference set of documents was a larger set of representative questions. Note that in FIG. 3, the first-ranked question 301 is “Find the number of alligators whose total mass is the same as 1.0 mol birds?” which has a DS score equal to 29.07. And the lowest ranked question 318 is “How to make a video on . . . ?” which has a DS score equal to 11.93.

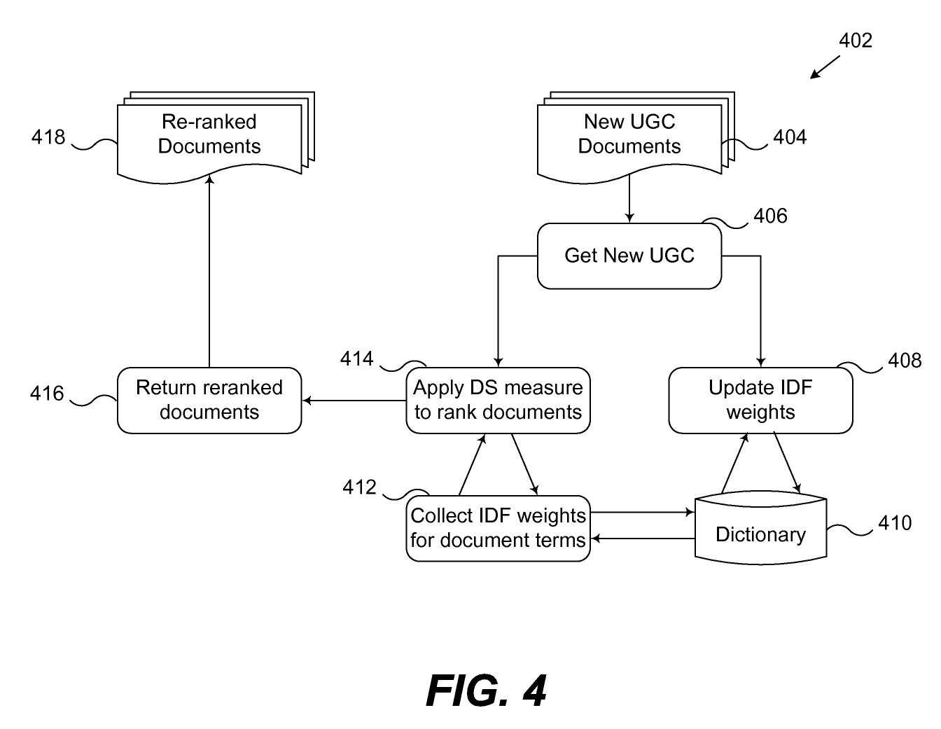

FIG. 4 shows an exemplary system architecture 402 that implements the method 102 of FIG. 1. New UGC documents arrive 402 and are selected 406 for updating IDF weights (or other term-specificity values) 408. For example, all UGC documents can be used to adjust the weights or alternative a limited (e.g., random) selection may be used. The IDF weights can be updated 408 in connection with maintaining dictionary of terms (e.g., words) with corresponding IDF weights an counts for the number of documents containing each term. The updated IDF weights can then be accessed 412 to calculate DS values 414 for ranking documents at the site 416. After the documents are re-ranked 416, they can be displayed 418 at the site (e.g., as in FIG. 3).

For ease of implementation, the processes for updating IDF weights 408 and ranking documents 414 can by carried out asynchronously. By making an empirical evaluation of the relevant documents, the ranking can reflect specificity relative to documents at the site in an automatic way that does not require undesirable user interaction, which may increase costs and insert biases.

Depending on the requirements of the operational setting, one or more values for the results of the method 102 can be output to a user or saved for subsequent use. For example the rankings 418 can be displayed directly and the dictionary entries 410 (e.g., terms, weights, running counts) can be saved for subsequent use. Alternatively, some derivative or summary form of the results (e.g., averages, etc.) can be saved for later use according to the requirements of the operational setting.

Additional embodiments relate to an apparatus for carrying out any one of the above-described methods, where the apparatus includes a computer for executing computer instructions related to the method. In this context the computer may be a general-purpose computer including, for example, a processor, memory, storage, and input/output devices (e.g., keyboard, display, disk drive, Internet connection, etc.). However, the computer may include circuitry or other specialized hardware for carrying out some or all aspects of the method. In some operational settings, the apparatus may be configured as a system that includes one or more units, each of which is configured to carry out some aspects of the method either in software, in hardware or in some combination thereof. For example, the system may be configured as part of a computer network that includes the Internet. At least some values for the results of the method can be saved for later use in a computer-readable medium, including memory (e.g., RAM (Random Access Memory)) and permanent storage (e.g., a hard-disk system).

Additional embodiments also relate to a computer-readable medium that stores (e.g., tangibly embodies) a computer program for carrying out any one of the above-described methods by means of a computer. The computer program may be written, for example, in a general-purpose programming language (e.g., C, C++) or some specialized application-specific language. The computer program may be stored as an encoded file in some useful format (e.g., binary, ASCII).

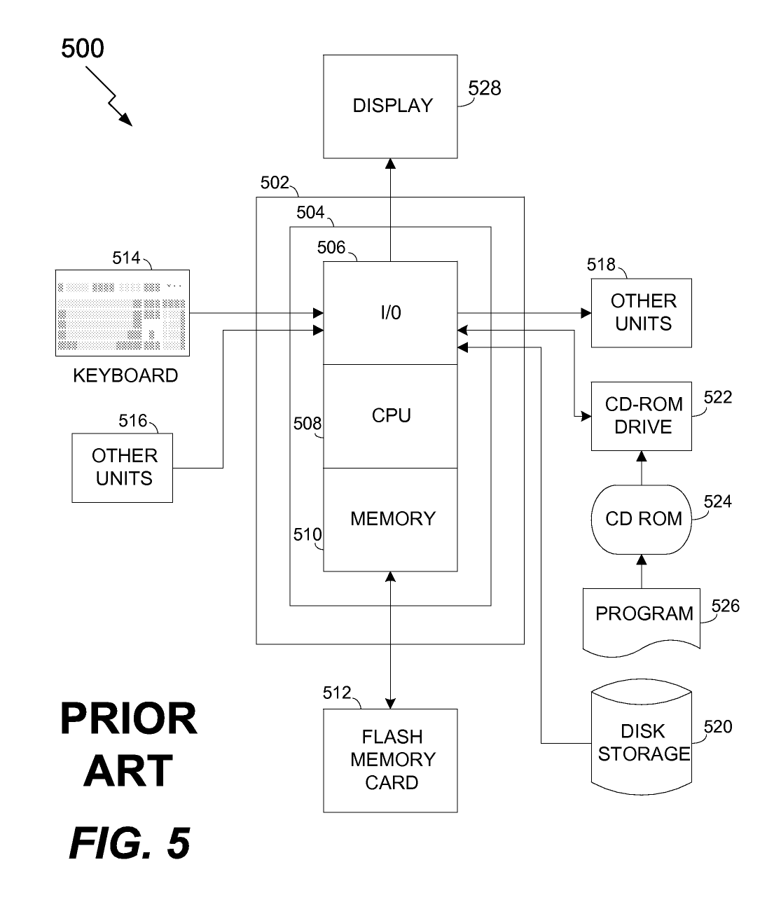

As described above, certain embodiments of the present invention can be implemented using standard computers and networks including the Internet. FIG. 5 shows a conventional general purpose computer 500 with a number of standard components. The main system 502 includes a motherboard 504 having an input/output (I/O) section 506, one or more central processing units (CPU) 508, and a memory section 510, which may have a flash memory card 512 related to it. The I/O section 506 is connected to a display 528, a keyboard 514, other similar general-purpose computer units 516, 518, a disk storage unit 520 and a CD-ROM drive unit 522. The CD-ROM drive unit 522 can read a CD-ROM medium 524 which typically contains programs 526 and other data.

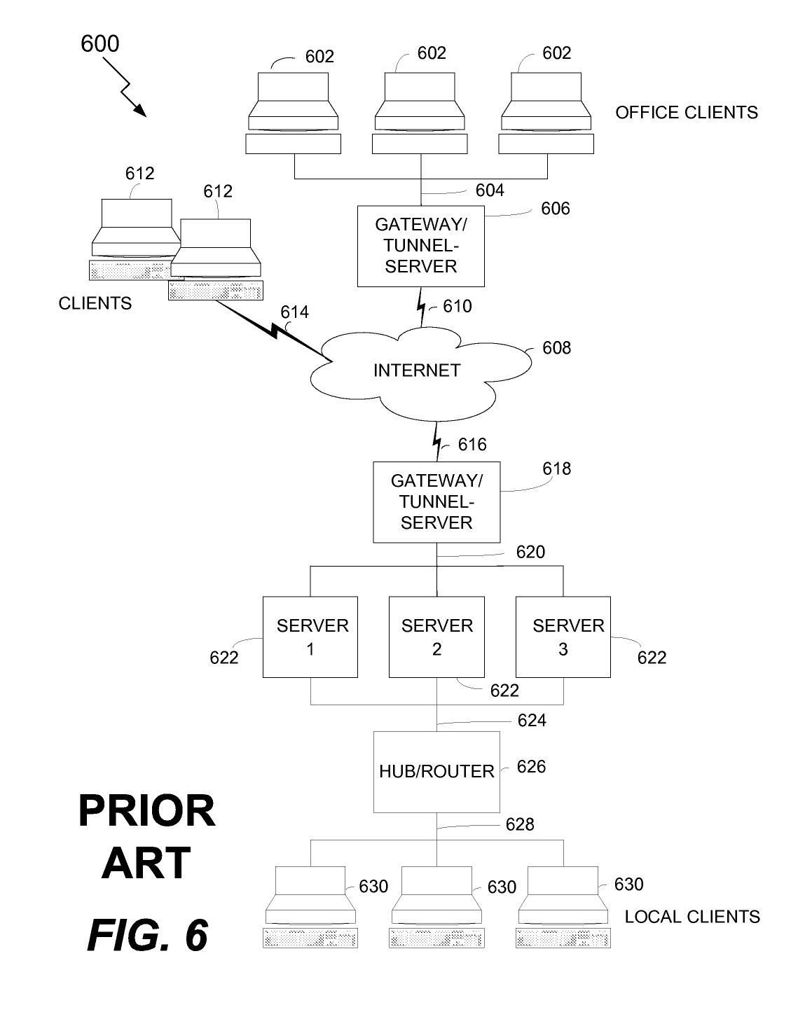

FIG. 6 shows a conventional Internet network configuration 600, where a number of office client machines 602, possibly in a branch office of an enterprise, are shown connected 604 to a gateway/tunnel-server 606 which is itself connected to the Internet 608 via some internet service provider (ISP) connection 610. Also shown are other possible clients 612 similarly connected to the Internet 608 via an ISP connection 614. An additional client configuration is shown for local clients 630 (e.g., in a home office). An ISP connection 616 connects the Internet 608 to a gateway/tunnel-server 618 that is connected 620 to various enterprise application servers 622. These servers 622 are connected 624 to a hub/router 626 that is connected 628 to various local clients 630.

Although only certain exemplary embodiments of this invention have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

What is claimed is:

1. A method of ranking documents by specificity values, comprising:
specifying a reference set of documents, each document including one or more terms;
specifying a first document that includes one or more terms that are included in the reference set of documents;
determining, from the reference set of documents, one or more term-specificity values for the one or more terms of the first document by calculating frequencies of terms within the reference set of documents, wherein a larger term-specificity value corresponds to a lower likelihood relative to the reference set of documents;
determining a document-specificity value for the first document by combining the one or more term-specificity values for the first document, wherein larger term-specificity values correspond to a larger document-specificity value; and
saving one or more values for the document-specificity value of the first document in a computer-readable medium.

2. A method according to claim 1, further comprising:
calculating term specificity values for terms in the reference set of documents as inverse document frequency values relative to the reference set of documents by comparing a number of documents including each term to a total number of documents.

3. A method according to claim 1, further comprising:
calculating the document-specificity value for the first document as a non-negative arithmetic combination of the corresponding term specificity values.

4. A method according to claim 1, wherein determining the document-specificity value for the first document includes calculating a norm of a vector that includes the corresponding term-specificity values.

5. A method according to claim 1, wherein the reference set of documents includes the first document.

6. A method according to claim 1, further comprising:
specifying a plurality of input documents that include one or more terms that are included in the reference set of documents, wherein the input documents include the first document;
determining, from the reference set of documents, one or more term-specificity values for the one or more terms of each input document;
determining, from the one or more term-specificity values for each input document, a document-specificity value for each input document;
determining a rank ordering of the input documents corresponding to an ordering of the document-specificity values of the documents; and
saving one or more values for the rank ordering in the computer-readable medium.

7. A computer-readable medium that stores a computer program for ranking documents by specificity values, wherein the computer program includes instructions for:
specifying a reference set of documents, each document including one or more terms;
specifying a first document that includes one or more terms that are included in the reference set of documents;
determining, from the reference set of documents, one or more term-specificity values for the one or more terms of the first document by calculating frequencies of terms within the reference set of documents, wherein a larger term-specificity value corresponds to a lower likelihood relative to the reference set of documents;
determining a document-specificity value for the first document by combining the one or more term-specificity values for the first document, wherein larger term-specificity values correspond to a larger document-specificity value; and
saving one or more values for the document-specificity value of the first document.

8. A computer-readable medium according to claim 7, wherein the computer program further includes instructions for:
calculating term specificity values for terms in the reference set of documents as inverse document frequency values relative to the reference set of documents by comparing a number of documents including each term to a total number of documents.

9. A computer-readable medium according to claim 7, wherein the computer program further includes instructions for:
calculating the document-specificity value for the first document as a non-negative arithmetic combination of the corresponding term specificity values.

10. A computer-readable medium according to claim 7, wherein determining the document-specificity value for the first document includes calculating a norm of a vector that includes the corresponding term-specificity values.

11. A computer-readable medium according to claim 7, wherein the reference set of documents includes the first document.

12. A computer-readable medium according to claim 7, wherein the computer program further includes instructions for:
specifying a plurality of input documents that include one or more terms that are included in the reference set of documents, wherein the input documents include the first document;
determining, from the reference set of documents, one or more term-specificity values for the one or more terms of each input document;
determining, from the one or more term-specificity values for each input document, a document-specificity value for each input document;
determining a rank ordering of the input documents corresponding to an ordering of the document-specificity values of the documents; and
saving one or more values for the rank ordering.

13. An apparatus for ranking documents by specificity values, the apparatus comprising a computer for executing computer instructions, wherein the computer includes computer instructions for:
specifying a reference set of documents, each document including one or more terms;
specifying a first document that includes one or more terms that are included in the reference set of documents;
determining, from the reference set of documents, one or more term-specificity values for the one or more terms of the first document by calculating frequencies of terms within the reference set of documents, wherein a larger term-specificity value corresponds to a lower likelihood relative to the reference set of documents;
determining a document-specificity value for the first document by combining the one or more term-specificity values for the first document, wherein larger term-specificity values correspond to a larger document-specificity value; and
saving one or more values for the document-specificity value of the first document.

14. An apparatus according to claim 13, wherein the computer further includes computer instructions for:
calculating term specificity values for terms in the reference set of documents as inverse document frequency values relative to the reference set of documents by comparing a number of documents including each term to a total number of documents.

15. An apparatus according to claim 13, wherein the computer further includes computer instructions for:
calculating the document-specificity value for the first document as a non-negative arithmetic combination of the corresponding term specificity values.

16. An apparatus according to claim 13, wherein determining the document-specificity value for the first document includes calculating a norm of a vector that includes the corresponding term-specificity values.

17. An apparatus according to claim 13, wherein the reference set of documents includes the first document.

18. An apparatus according to claim 13, wherein the computer further includes computer instructions for:
specifying a plurality of input documents that include one or more terms that are included in the reference set of documents, wherein the input documents include the first document;
determining, from the reference set of documents, one or more term-specificity values for the one or more terms of each input document;
determining, from the one or more term-specificity values for each input document, a document-specificity value for each input document;
determining a rank ordering of the input documents corresponding to an ordering of the document-specificity values of the documents; and
saving one or more values for the rank ordering.

19. An apparatus according to claim 13, wherein the computer includes a processor with memory for executing at least some of the computer instructions.

20. An apparatus according to claim 13, wherein the computer includes circuitry for executing at least some of the computer instructions.
